(19) United States
(12) Patent Application Publication
(10) Pub. No.: US 2014/0314928 A1
(43) Pub. Date: Oct. 23, 2014

(54) METHOD AND UNIT FOR THE PROCESSING OF SUNFLOWER-EXTRACTION MEAL

(71) Applicants: Erhard Bazak, Dortmund (DE); Andreas Freiherr von Tautphoeus, Oberhasli (CH)

(72) Inventors: Erhard Bazak, Dortmund (DE); Andreas Freiherr von Tautphoeus, Oberhasli (CH)

(21) Appl. No.: 14/352,700

(22) PCT Filed: Oct. 17, 2012
(86) PCT No.: PCT/EP2012/070589

§ 371 Date: Apr. 18, 2014

(30) Foreign Application Priority Data
Oct. 21, 2011 (DE) 10 2011 116 564.2

(51) Int. Cl. A23K 1/14; C10L 5/44; B02C 23/14; B02C 4/08; B02C 11/02

(52) U.S. Cl. CPC A23K 1/14; B02C 4/08; B02C 11/02; B02C 23/14; C10L 5/445
USPC 426/481; 241/68; 241/76; 44/605; 44/589

(57) ABSTRACT

An optimal separation of sunflower seed meal into at least one fraction with high protein content and at least one fraction with high cellulose content is to be achieved with a method for the processing of sunflower-extraction meal, producing a fraction with a low protein content for use as fuel and a fraction having a higher protein content for use as animal feed, wherein the extraction meal is fed to a plurality of dissolving and extraction stages. This is achieved by—at least two protein removal steps, preferably by means of corrugated rolls or hammer blows or impact mills with impactation of the starting material in a short cycle sequence,—the subsequent sifting by means of sieves, as well as the collecting of the sifted material and the remaining coarse material.

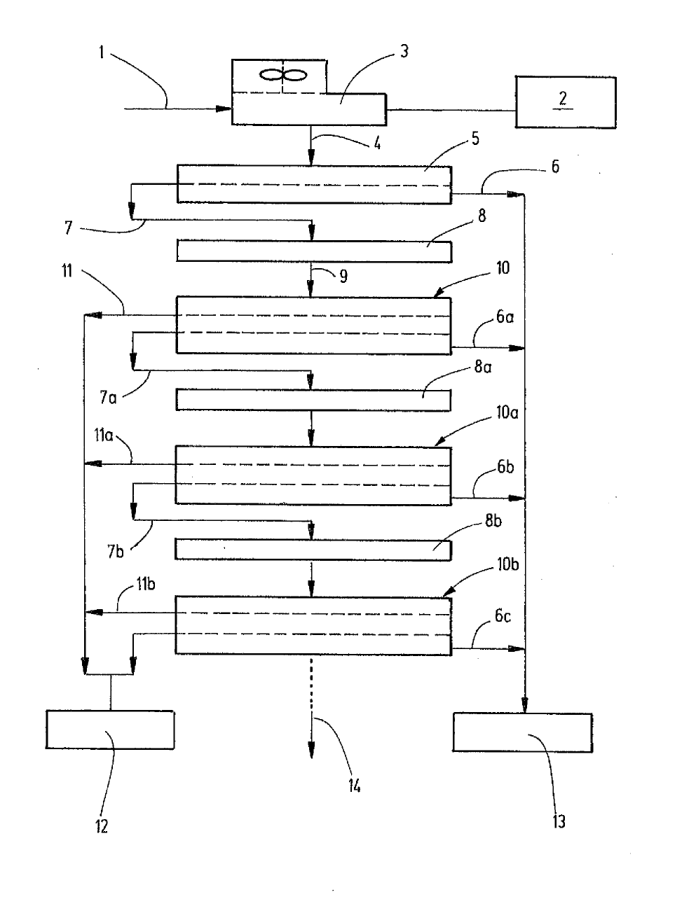

The invention is directed at a method and a system for processing of sunflower extraction meal, of the type indicated in the preamble of claims 1 and 10, respectively.

There are a number of methods for separating the extraction meal obtained from grains or legumes, for example, perhaps after the extraction of oil, into a protein-enriched fraction and a fraction having a lower protein content, possibly to obtain the fractions, in each instance, as an animal feed or, in pelletized form, as a fuel.

A method and a system for processing of such extraction meal from sunflower seeds, for animal nutrition, is known from WO 02/080699 A2 (EP 1 372 409). After comminution and screening steps, separation by means of an air separator also follows, whereby the first fraction is supposed to contain a higher proportion of raw protein than the second fraction. Pulverization of the material is accepted, in this connection. The resulting raw fibers can be macerated using a lye maceration process, in order to increase their digestibility or their energy value.

A method for the utilization of oil plants is described in EP 2 163 159 A1, which plants are partly processed to utilize them for energy, as fuel for the production of electricity and usable heat.

Protein enrichment in cereals, particularly grains and legumes, is described in EP 0 919 294 A1, whereby a high-protein and a low-protein fraction are produced by means of grinding and air separation.

A method for extraction of the components of pea flour is described by US 2004/0091600 A1, whereby here, separation by means of introduction of the flour into water takes place, in part.

The aforementioned methods are not satisfactory with regard to their protein yield and the purity of the fractions, in each instance, and in part are very complicated in terms of their method of procedure.

It is the task of the invention to create a method and a system with which optimal separation of sunflower extraction meal into at least one fraction having a high protein content and at least one fraction having a high cellulose content is obtained, whereby pulverization of the separated products is avoided to the greatest possible extent.

This task is accomplished with a method of the type indicated initially, according to the invention, by means of the following method steps:
at least two protein detachment steps, preferably by means of corrugated rolls or hammer mills or impact mills, with impact stress on the starting material, in a short cycle sequence,
subsequent separation by means of screening, and
collection of the screened material and of the remaining coarse material.

It has been shown that with the method of procedure according to the invention, it can be achieved that a protein content of the more high-protein fraction of more than 40 wt.-% is possible, while the “fuel fraction” can have a protein content of less than 12 wt.-%.

At this point, it should be noted that wt.-% is understood to mean the percentage weight proportion with reference to the dry substance.

The desired yield can be achieved by means of impact stress on the starting material, in short cycles of about 8 to 20 seconds, and subsequent screening.

The task mentioned above is also accomplished by means of a system that is characterized by a first drying system for the starting material, a lump crusher for treatment of possible lumps and clumps in the starting material, at least two corrugated rolls or hammer mills or impact mills for protein detachment, at least two plansifters for screening the material, as well as having conveying and collection devices for the screened product, in each instance, and the medium or coarse material, in each instance, and at least one device for pelletizing at least one fraction obtained.

Further embodiments of the invention are evident from the dependent claims. lf, for example, large amounts of primary material are delivered from the oil mills, so that interim storage of the primary material is required, the invention provides that drying of the starting material and, if necessary, crushing of lumps on the starting material precedes the first protein detachment step.

According to the invention, it can also be provided, for example, that after a protein detachment step, with screening, the fractions containing protein are drawn off, a center fraction is passed on to the next protein detachment step, and a fuel fraction is drawn off.

If, for example, plansifters are used as separation apparatuses, as the invention provides, then it is practical if these are equipped with two screens, in such a manner that a fraction that is assigned to the low-protein fraction remains on the upper screen, having the larger mesh width, and a center fraction that is passed on to further processing remains on the second screen, while the particles that fall through the second screen are assigned to the high-protein fraction.

The invention provides, in an embodiment, that the fractions produced in the preliminary stages and in the last step are combined and subjected to a pelleting process, if applicable.

With this embodiment, the result is achieved that the products, in each instance, can be removed from every treatment step, unless they are passed on to further processing, and can be pelletized, if applicable. Thus, the fraction that has a very low protein content, for example, can be processed to produce fuel pellets. The high-protein fraction can be pelletized accordingly, in order to be made available to the consumer as animal feed pellets.

It can be practical that after drying of the starting material, a first separation is carried out as pre-screening, using a plansifter having a mesh width of 200 to 500 μm and/or that the further separations is carried out after the protein detachment steps, in each instance, using plansifters having a first mesh width of 400 to 1000 μm and a second mesh width of 200 to 400 μm, whereby it can also be provided that the mesh widths are selected smaller from one separation step to another separation step.

In order to achieve a final separation of the particles still remaining in the system, it can be provided that for the last separation step, a plansifter having three mesh widths of 800, 500, and 200 μm are used.

In order to allow a continuous method of operation in practice, if at all possible, it can also be provided that the primary material that comes from oil mills is first passed to a dryer and then to a cooling device. Such a measure can be particularly practical if the primary material coming from the oil mills cannot be fed into the processing process immediately, but rather must be subjected to interim storage.

Further characteristics, details, and advantages of the invention are evident from the following description and from the drawing. This drawing, in the single FIGURE, shows a flow chart of the method according to the invention.

The sunflower extraction meal starting material coming from the oil mills is passed to the method at 1, for example, and is dried by way of a drying system 3 if at least part of it is supposed to be passed to an intermediate storage unit 2. The material to be processed is passed to a first screening stage 5 according to the arrow 4, whereby the fine-grained component is transferred out at 6; this is the high-protein fraction. The coarse component is passed to a first dissolution step according to the arrow 7, for example by means of a corrugated roll. This first dissolution step is indicated as 8. Here, an impact mill can also be used, for example.

The material processed in this way is applied to a second separator or precipitator 10, according to the arrow 9, whereby the coarse material is transferred out according to the arrow 11, the intermediate material is passed to the next dissolution stage 8a according to the arrow 7a, while the fine material is transferred out according to the arrow 6a.

The subsequent treatment stages are comparable in terms of their structure. In the next stage, the material that leaves the dissolution step 8a is passed to the next sifter 10a, the course material is transferred out according to the arrow 11a, and the fine material is passed to the other fine material according to the arrow 6b. Once again, the “middle material” removed from the lower screen is passed to a further dissolution stage 8b, and once again, the coarse material is transferred out according to the arrow 11b and the high-protein material is collected according to the arrow 6c.

As indicated, the intermediate material from the last stage can be combined together with the coarse material from the preceding stages, in the final step, and can be passed to a pelleting system 12, for example. Also, the high-protein material that was withdrawn according to the arrows 6, 6a, 6b, and 6c, can be passed to a pelleting system 13 or granulation system, depending on the type of use. Of course, it can also be passed to further use as a powder, without having been pelletized first.

The dotted arrow 14 also indicates that the number of treatment steps represented here can be increased further, whereby then, corresponding indicated screening devices with screens having different mesh widths can be used.

In place of the corrugated rolls that bring about a dissolution step, other types of rolls or treatment steps can also be provided at the respective location, whereby different types of impact on the sunflower extraction meal can also be provided, stage by stage.

### REFERENCE SYMBOL LIST

1 method

2 intermediate storage unit

3 drying system

4 arrow

5 first screening stage

6 arrow

6a arrow fine material

6b arrow

6c arrow

7 arrow

7a arrow intermediate material

7b arrow

8 first dissolution step

8a dissolution stage

8b dissolution stage

9 arrow

10 sifter

10a sifter

10b plansifter

11 arrow

11a arrow coarse material

11b arrow

12 pelleting system

13 pelleting system

14 further treatment stages

1. Method for processing of sunflower extraction meal, with the production of a fraction having a low protein content for use as a fuel and a fraction having a higher protein content for use as animal feed, wherein the extraction meal is passed to multiple dissolution and separation stages, comprising
at least the following method steps:
at least two protein detachment steps, preferably by means of corrugated rolls or hammer mills or impact mills, with impact stress on the starting material, in a short cycle sequence,
subsequent separation by means of screening, and
collection of the screened material and of the remaining coarse material.

2. Method according to claim 1, wherein
drying of the starting material and, if necessary, crushing of lumps or clumps in the starting material precedes the first protein detachment step.

3. Method according to claim 1, wherein
after a protein detachment step with screening, the fractions containing protein are drawn off, a middle fraction is passed to the next protein detachment step, and a fuel fraction is drawn off.

4. Method according to claim 1, wherein
the fractions produced in the preliminary stages and in the final step are combined and subjected to a pelleting/granulation step, if necessary.

5. Method according to claim 1, wherein
after drying of the starting material, a first separation as pre-screening with a plansifter having a mesh width of 200 to 500 μm is carried out.

6. Method according to claim 1, wherein
the further separations after the protein detachment steps, in each instance, are carried out with plansifters having a first mesh width of 400 to 1000 μm and a second mesh width of 200 to 400 μm.

7. Method according to claim 1, wherein
the mesh widths are selected to be smaller from one separation step to another separation step.

8. Method according to claim 1, wherein
for the last separation step, a plansifter having three mesh widths of 800, 500, and 200 μm is used.

9. Method according to claim 1, wherein
the primary material coming from the oil mills is first passed to a dryer and subsequently to a cooling device.

10. System for processing of sunflower extraction meal, with the production of a fraction having a low protein content for use as a fuel and a fraction having a higher protein content for use as animal feed, having devices for detachment of proteins from the extraction meal and devices for separation of the protein from coarse material, comprising
a first drying system (3) for the starting material, a lump crusher for treatment of the starting material, at least two corrugated rolls (8, 8a) or hammer mills for protein detachment, at least two plansifters (10, 10a) for screening the material, as well as having conveying and collection devices (6, 7, 11) for the screened product, in each instance, and the medium or coarse material, in each instance, and at least one device (12 or 13, respectively) for pelletizing or granulating at least one fraction obtained.

11. System according to claim 10, comprising
more than two corrugated roller mills (8, 8a) and plansifters (10, 10a) positioned one behind the other in the run, wherein the plansifters are equipped with a larger mesh width and a smaller mesh width, and the subsequent plansifter, in each instance, has mesh widths that become smaller per stage.

12. System according to claim 10, wherein
the last plansifter (10b) has three mesh widths of 800, 500, and 200 μm.

13. System according to claim 10, wherein
the first and/or the last detachment dissolution unit are/is configured as an impact mill.
